(19) United States
(12) Patent Application Publication
(10) Pub. No.: US 2012/0278146 A1
(43) Pub. Date: Nov. 1, 2012

(54) ONLINE SOCIAL BRAND AMBASSADORS

(75) Inventors: Dale Nussel, Mahomet, IL (US); Jonathan Kilroy, Champaign, IL (US); Allie K. Watfa, Urbana, IL (US); Anupam Seth, Urbana, IL (US)

(73) Assignee: Yahoo! Inc., Sunnyvale, CA (US)

(21) Appl. No.: 13/094,640

(22) Filed: Apr. 26, 2011

(51) Int. Cl. G06Q 30/00

(52) U.S. Cl. 705/14.16

(57) ABSTRACT

Techniques are provided which allow users to become online ambassadors for their favorite brands and products. Methods and systems may detect if a user is associated with a particular brand or product. The user may be presented with an offer to act as an ambassador for that brand or product. If the user accepts, the system may determine if at least a portion of the user's online activities are directed to promoting the brand or product. The user may then be presented with one or more rewards based at least in part on the user's promoting of the brand. The rewards may include rewards points, cash rewards, coupons, discounts and other incentives.

### BACKGROUND

People are naturally very often strongly influenced by the feedback, comments and opinions, or purchases of others in their social network before, for example, making a purchase. For example, an individual knowing that a family member or friend has commented positively on a certain brand or product, or recently bought a product of a certain brand, may well positively influence the chances that the individual will make a similar purchase.

There is a need for techniques in online advertising relating to, among other things, encouraging users to promote or publicize their favorite brands and/or products.

### SUMMARY

Some embodiments of the invention provide systems and methods in which users who are or who may like to be associated with certain brands and/or products may be detected by one or more computers based at least in part on e.g., user search history information, user purchase history information, user profile information, etc. The detected users may then be presented with an offer to act as ambassadors (i.e., represent the brand and/or product in a promotional capacity) for the brand and/or product. The offer may be presented by the advertiser (i.e., the brand) or a third party entity (e.g., Yahoo!), or in combination by both entities.

In accordance with exemplary embodiments, users who accept offers to act as ambassadors for certain brands and/or products may advertise or promote those brands and/or products a number of ways. For example, users may post status updates on their social networking platform to advertise for a brand and/or product. A user may post, for example, “gap.com is having a huge sale!” as a status update to alert his social network of the sale. Another way users may advertise is by promoting the brands and/or products in emails and/or IMs. For example, users may create an email and/or IM signature with text, logos, and/or other graphical information to promote the brand and/or product. An email and/or IM signature might include a statement such as, for example, “I just got Puma Pro Soccer shoes . . . they're awesome!” In addition, it may include hyperlinks, logos, slogans and other graphical or textual information. Thus, every individual who receives emails and/or IMs from the user will see the user promoting the brands and/or products.

In some embodiments, the user may promote the brands and/or products by displaying a customized avatar, or other visual or multimedia electronic character or manifestation of an entity associated with the user, for instance. The user may be offered the option to use a customized avatar which reflects one or more of the particular products and/or brands that the user is associated with. For example, if the user has recently purchased a pair of Puma shoes, the user may be given the option to use an avatar which shows those particular shoes. Alternatively, or in addition, the user may be given the option to customize or create the avatar by selecting the brands and/or products the user wants reflected in the avatar. The avatar may then be displayed on social networking platforms, message boards, online services like Yahoo! Fantasy Football, etc.

In accordance with exemplary embodiments, users who advertise or promote their favorite brands and/or products may be rewarded for their promotional activities. The type and amount of the reward may vary based at least in part on, for example, the number of social networking platforms utilized in the promotions, the duration of the promotions, the number of individuals who viewed the promotions, etc. Rewards may include, for example, cash rewards, rewards points, coupons, discounts, and other incentives.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

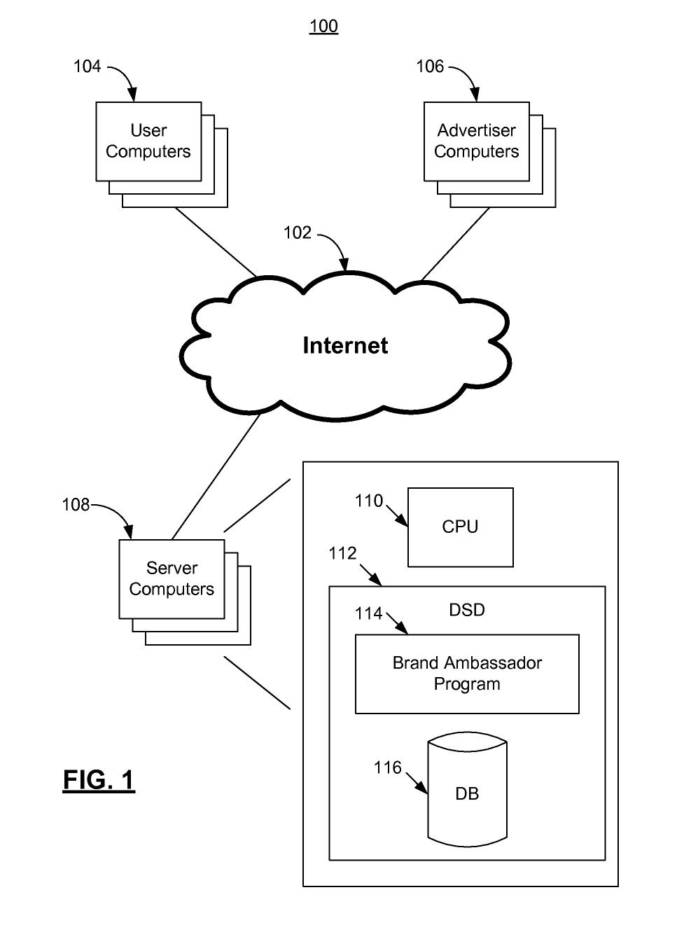

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, social networking related advertisements, mobile advertisements, discount or group discount advertisements, etc.

As depicted, each of the server computers 108 includes one or more CPUs 110 and a data storage device 112. The data storage device 112 includes a database 116 and a Brand Ambassador Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

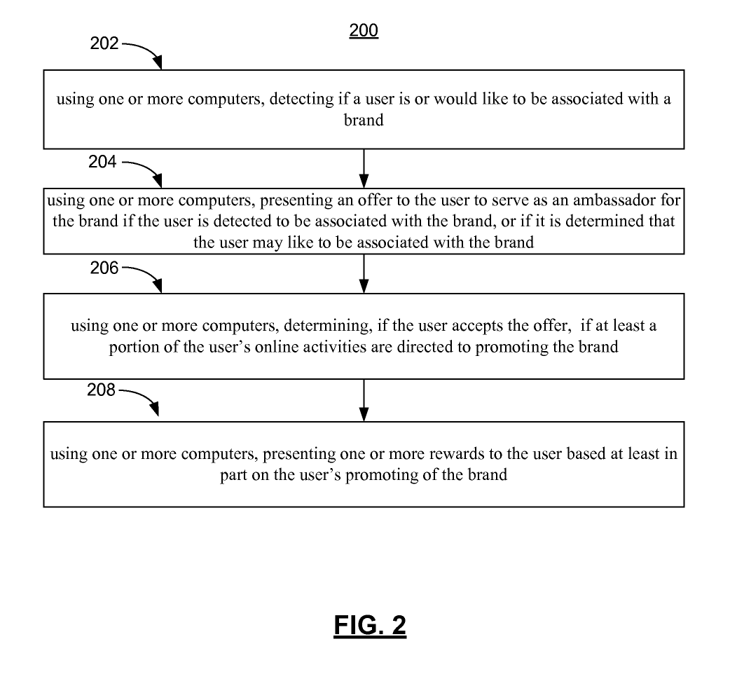

FIG. 2 is a flow diagram illustrating a method 200 according to one embodiment of the invention. At step 202, using one or more computers, it is detected if a user is or would like to be associated with a brand.

At step 204, using one or more computers, an offer to serve as an ambassador for the brand is presented to the user if the user is detected to be associated with the brand, or if it is determined that the user may like to be associated with the brand.

At step 206, using one or more computers, it is determined, if the user accepts the offer, if at least a portion of the user's online activities are directed to promoting the brand.

At step 208, using one or more computers, if at least a portion of the user's online activities are directed to promoting the brand, the user is presented with one or more rewards based at least in part on the user's promoting of the brand.

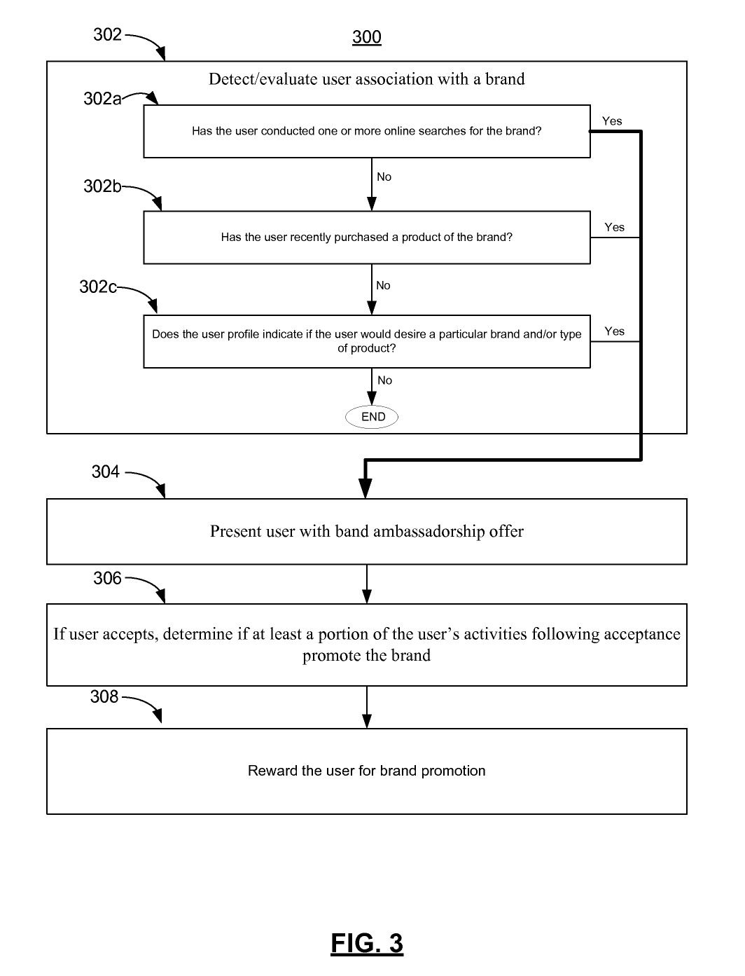

FIG. 3 is a flow diagram illustrating a method 300 according to one embodiment of the invention. At step 302, using one or more computers, it is detected if a user is or would like to be associated with a brand. Whether a user is associated, or would like to be associated, with a particular brand and/or product may be determined various different ways. For example, if the user has recently conducted one or more online searches for a particular brand and/or product as shown in step 302a, then it may be determined that the user is or would like to be associated with that particular brand and/or product. Another way to determine if a user is or would like to be associated with a brand and/or product is to determine, as shown in step 302b, if the user has recently purchased a particular product. For example, if the user's purchase history indicates that the user has recently purchased a pair of Nike shoes, then it may be determined that the user is or would like to be associated with Nike to earn future discounts or incentives for Nike products. In some embodiments, exemplary method 300 may be used to determine or predict if a user may like to be associated with a particular brand and/or product. As shown in step 302c, if the user's online profile indicates that the user desires certain brands and/or products, it may be determined that the user may like to be associated with and promote those brands and/or products in exchange for discounts and other incentives. For example, if a user's online profile indicates that the user is a mother to-be, it may be determined based on this information that the user may like to be an ambassador for a certain brand of diapers. The prospect of future discounts on that brand of diapers may serve to entice the user into accepting the offer to be an ambassador for that particular brand.

At Step 304, brand ambassadorship is offered to an appropriate user. This can include, using one or more computers, providing an offer to serve as an ambassador for the brand to the user if the user is detected to be associated with the brand, or if it is determined that the user may like to be associated with the brand.

Step 306 may include, using one or more computers, if the user accepts the offer, determining if at least a portion of the user's online activities are directed to promoting the brand.

Step 308 may include, using one or more computers, if at least a portion of the user's online activities are determined to be directed to promoting the brand, presenting the user with one or more rewards based at least in part on the user's promoting of the brand.

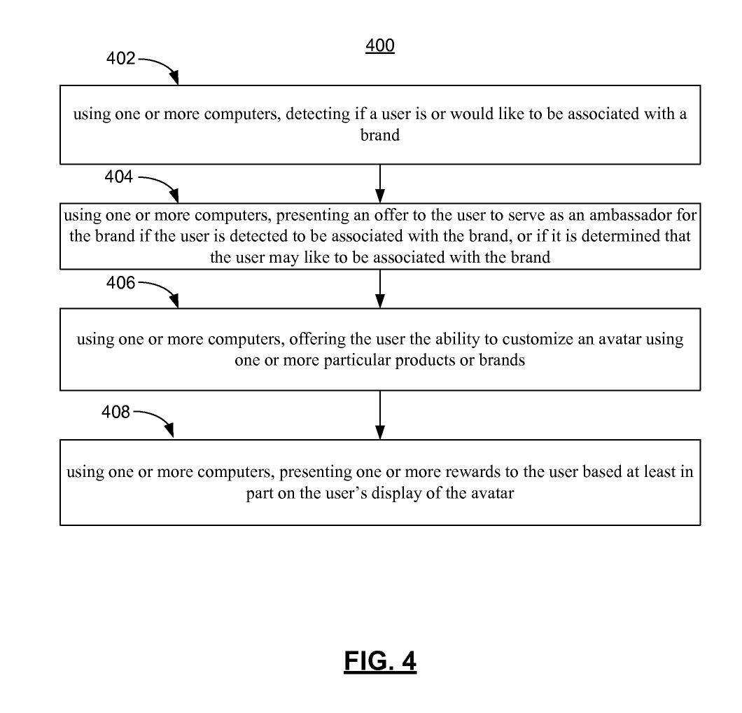

FIG. 4 is a flow diagram illustrating a method 400 according to one embodiment of the invention. At step 402, using one or more computers, it is detected if a user is or would like to be associated with a brand.

At step 404, using one or more computers, an offer to serve as an ambassador for the brand is presented to the user if the user is detected to be associated with the brand, or if it is determined that the user may like to be associated with the brand.

At step 406, using one or more computers, the user is offered the option to use a customized avatar which shows one or more of the particular products and/or brands that the user is associated with. For example, if the user has recently purchased a pair of Nike shoes, the user may be given the option to use an avatar which shows those particular shoes. Alternatively, or in addition, the user may be given the option to customize the avatar, or provide specifications for the system to customize the avatar according to those specifications.

At step 408, using one or more computers, the user is presented with one or more rewards based at least in part on the user's display of the avatar. The rewards and/or other incentives may be based at least in part on, for example, the number of social networking platforms the avatar is displayed on, the duration the avatar is displayed, etc.

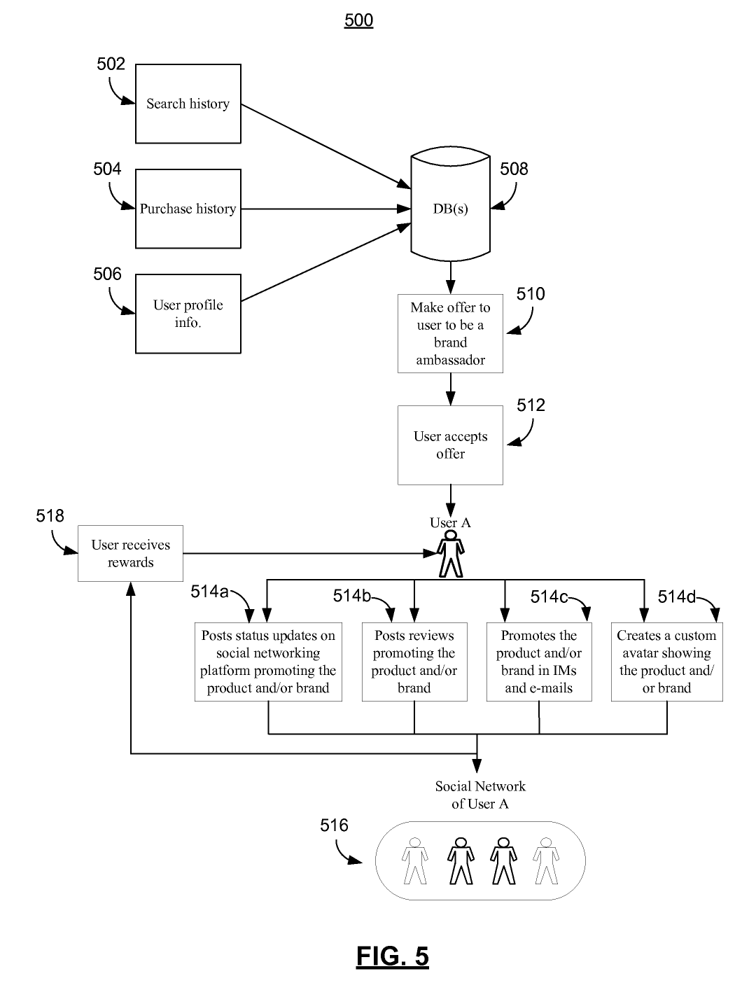

FIG. 5 is a block diagram 500 illustrating one embodiment of the invention. One or more data stores or databases 508 are depicted. Various types of information are stored in the database 508, which information may be obtained, gathered, or generated in various ways. Database 508 may be located in, for example, one or more server computers 108 (FIG. 1) and/or one or more advertiser computers 106 (FIG. 1). In particular, types of depicted information relating to a user is stored in the database 508 include online search history information 502, purchase history information 504 and user profile information 506. As depicted at block 510, one or more of these types of information, possibly among other types, may be used to determine if an offer to be an ambassador for a certain brand and/or product should be made to User A. For example, if User A has conducted online searches for Nike, and/or recently purchased a pair of Nike shoes, and/or the user's online profile indicates that he likes Nike products, User A may be presented an offer to be an ambassador for Nike or a particular Nike product (e.g., the shoes purchased by the user). The offer may be presented electronically to one or more user computers 104 (FIG. 1) by one or more advertiser computers 106 (FIG. 1) and/or one or more server computers 108 (FIG. 1). If User A accepts the offer, as depicted in block 512, User A may promote the brand and/or product as depicted in blocks 514a-514d. As shown in blocks 514a-514c, User A may post reviews, status updates, create email and/or IM signatures to promote the brand and/or product. In addition, User A may be given an option to create a custom avatar showing the particular product and/or brand, as depicted in block 514d. For example, the system may allow the user to create a custom avatar wearing the shoes the user purchased. Alternatively, the system may create the avatar and give the user the option to use it. The avatar, whether created by the user or the system, may be displayed on the user's social networking platform, IM platform, message board, etc.

User A's social network 516 may view or notice User A's comments and/or praises about the brand and/or product. This may convince one or more members of User A's social network to purchase the same or similar product as purchased by User A. In some embodiments, User A may be rewarded based at least in part on User A's promoting of the brand and/or product as depicted in block 518. The reward or incentive may be determined based at least in part on one or more of the number of social networking platforms utilized in promotions, number of individuals who viewed the promotions, duration of promotions, quality of promotions, etc. The reward may be provided by the advertising entity (e.g., the brand that the user is advertising for) and/or a third party entity (e.g., Yahoo!) or in some combination by both entities.

The above described exemplary embodiments of the invention assist consumers in deciding what brands and/or products to purchase and provide an incentive for users to promote their favorite brands and/or products. The number of products available for purchase in any given category is increasing exponentially. Thus, it has become difficult for consumers to decide which brands and/or products to purchase. Consumers may rely on blogs, reviews, etc. before making a purchase decision. However, since consumers don't personally know the authors behind the blogs, reviews, etc. it may be difficult for them to trust these sources. Consumers typically tend to trust reviews, comments, opinions regarding brands and/or products from their peers. Exemplary embodiments of the invention therefore provide an incentive for users who have purchased or are likely to purchase certain brands and/or products to promote those brands and/or products. Users who carry out promotional measures may be rewarded with rewards points, discounts, coupons, cash rewards, etc. Potential consumers who are on the receiving end of the promotional measures will be more likely to be receptive to them since the source is one of their own peers.

In accordance with exemplary embodiments of the invention, users who are or who may like to be associated with certain brands and/or products may be detected by one or more computers (e.g., server computers 106 and/or advertiser computers 108 in FIG. 1) based at least in part on information received from e.g., user computers 104 in FIG. 1. The detected users may then be presented with an offer to act as ambassadors (i.e., represent the brand and/or product in a promotional capacity) for the brand and/or product by one or more computers (e.g., server computers 106 and/or advertiser computers 108 in FIG. 1). The user may receive the offer electronically on e.g., one or more user computers 104 (FIG. 1). A user may be detected to be associated with a certain brand and/or product if the user is determined to have made a purchase a certain brand and/or product, or is likely to purchase a certain brand and/or product. For example, if a user has conducted one or more online searches for an Adidas soccer ball, then it may be determined that the user is likely to purchase an Adidas soccer ball. As a result, the user may be presented with an offer to be an ambassador for the Adidas soccer ball.

Alternatively, or in addition, another way to detect if a user is or would like to be associated with a particular brand and/or product is to determine if the user has recently purchased a product. For example, if a user uses an online service to purchase a Toyota Corolla, then the user may be presented with an offer to act as an ambassador for Toyota. In return, the user may receive an offer, for example, for a free oil change. In another exemplary method, a user's online profile may be used to determine if the user is or would like to be associated with a particular brand and/or product. For example, if the user's online profile indicates that she likes Coach hand bags, she may be presented with an offer to act as an ambassador for Coach. It should be noted that the above described exemplary methods to detect if a user is or would like to be associated with a particular brand and/or product may be utilized independently or in combination with each other and with other methods.

In accordance with exemplary embodiments, users who accept offers to act as ambassadors for certain brands and/or products may advertise or promote those brands and/or products a number of ways. For example, users may post status updates on their social networking platform to advertise for a brand and/or product. A user may post, for example, “gap.com is having a huge sale!” as a status update to alert his social network of the sale. Another way users may advertise is by promoting the brands and/or products in emails and/or IMs. For example, users may create an email and/or IM signature with text, logos, and/or other graphical information to promote the brand and/or product. An email and/or IM signature might include a statement such as, for example, “I just got Puma Pro Soccer shoes . . . they're awesome!” In addition, it may include hyperlinks, logos, slogans and other graphical or textual information. This way, every individual who receives emails and/or IMs from the user will see the user promoting the brands and/or products.

In some embodiments, the user may promote the brands and/or products by displaying a customized avatar. The user may be offered the option to use a customized avatar which reflects one or more of the particular products and/or brands that the user is associated with. For example, if the user has recently purchased a pair of Puma shoes, the user may be given the option to use an avatar which shows those particular shoes. Alternatively, or in addition, the user may be given the option to customize or create the avatar by selecting the brands and/or products the user wants reflected in the avatar. The avatar may then be displayed on social networking platforms, message boards, online services like Yahoo! Fantasy Football, etc.

In some embodiments, detection of a user's interest in or favorable disposition towards a brand may include categorization according to the type, level or quality of such. For example, in some embodiments, the following categories of candidates may be used. In some embodiments, the category may influence the nature or degree of incentive or reward, as the examples that follow illustrate.

### 1—Trending Ambassador:

User conducts frequent searches for a certain brand through one or more search engines. For example, if the user searches for “Adidas soccer ball” often, then the user might get a proposal from the system to be an ambassador for Adidas with coupons incentive to use and purchase a ball (20% coupon).

### 2—High Value Ambassador:

User purchases a product of high value online. For example, if the user uses an online service to purchase a new Toyota Corolla, then the user might get a proposal from the system to be an ambassador for Toyota car with an incentive for a free oil change.

Furthermore, in some embodiments, the system can predict or determine a good candidate ambassador. For example, if it can be determined that a user is preparing to be a mother, then the user might be a great candidate to be a brand ambassador of Pampers products with the benefits that may include getting special discounts on the product.

In some embodiments, a formula may be used for calculating a percentage of some reward to give to the brand ambassador. For example, the following may be utilized.

% Incentive={[(Number of Social applications engaged)*Wn+(Quality of ambassador)*Wt+(Time of commitment)*Wt+(Level of social Network communication)*W1]*100}/30 (Eq. 1)

In Eq. 1, the W terms are weighting factors which may be determined based on factors such as the relative importance given to the associated term, or the relative value of the associated term in promoting the brand.

In Eq. 1, number of Social applications engaged is the number of Y! applications that the user decided to use in brand ambassadorship activities. For example, instant messaging can be one, email another, and so on. For the sake of simplicity, the maximum value of this term is taken to be 5.

In Eq. 1, Quality of the Ambassador is the degree or level of quality of the ambassador. Quality may depend on the kind of ambassador the user is. For example, the following quality categories or ratings may be associated to the following types of ambassadors:
Trending Ambassador=value of 1
High Value Ambassador=value of 5
Predicting the ambassador=value of 3

In Eq. 1, the Time of Commitment term is to reflect that the more time that the user is willing to commit to being an ambassador, the greater the incentive should be. For example, for every 1 additional week of, or including, a certain level of time commitment, the value of this term may increase by 1, for the maximum of 10 weeks leading to a maximum value of 10 points.

In Eq. 1, the Level of social Network communication term may be dependent on the potential, or sometimes actual, number of social network members that saw or experience displayed branding of or from the brand ambassador. For example, if the number of members exceed a 1000, the value of this term may be 10, and for 900 to 1000, the value may be 9, etc.

With those numbers in mind, an example of the above formula maximum may be the following:

% Incentive={[(5)*1+(5)*1+(10)*1+(10)*1]*100}/20={20*100}/30=100% (Eq. 2).

There are many ways that an ambassador may promote a brand. Some ways are as follows.

### A—Social Status:

User can can set his or her Yahoo! Updates, and other social networking Web site or service status to advertise for a product (Example: Setting your status to indicate a sale going on gap.com).

### B—Email:

In some embodiments, user emails can be configured to include advertising for the brand. This can include, for example, an automatic email signature on every outgoing email, which may include advertising for a brand, such as an image of the Nike swish, and text saying “Nike”, etc. By showing the brand as part of every email sent, then the brand ambassador can share his or her brand preference with whomever the user is sending an email to.

### C—Instant Messaging:

A user may add textual information to his or her Instant Messaging status (Example: Tom Just got the PUMA Pro soccer shoes), and this can serve as advertising for the brand was just bought, preferred, etc.

### D—Avatar:

They System can offer an option for the brand ambassador use his or her avatar, in any of various applications, to promote a brand. For example, if the user just bought a new Coach handbag, then the avatar may carry the same handbag, which may serve as a nice lure for other online shoppers to notice this and to buy accordingly. This may be a particularly useful approach for younger users. Other examples can include Y! Buzz, etc.

In accordance with exemplary embodiments, the determined reward or incentive may be provided by the advertiser (i.e., the entity that the user is advertising for) or by a third party entity (e.g., Yahoo!), or in some combination by both entities.

While the invention is described with reference to the above drawings, the drawings are intended to be illustrative, and the invention contemplates other embodiments within the spirit of the invention.

1. A method comprising:
using one or more computers, detecting if a user is associated with a brand;
using one or more computers, if the user is detected to be associated with the brand, presenting an offer to the user to serve as an ambassador for the brand;
using one or more computers, if the user accepts the offer, determining if at least a portion of the user's online activities are directed to promoting the brand; and
using one or more computers, if at least a portion of the user's online activities are determining to be directed to promoting the brand, presenting one or more rewards to the user based at least in part on the user's promoting of the brand.

2. The method of claim 1, wherein detecting whether the user is associated with a brand comprises:
using one or more computers, determining if the user has conducted one or more on-line searches for the brand.

3. The method of claim 1, wherein detecting whether the user is associated with a brand comprises:
using one or more computers, determining if the user has used an online service to purchase a product of the brand.

4. The method of claim 1, wherein detecting whether the user is associated with a brand comprises:
using one or more computers, predicting if the user would like to promote the brand.

5. The method of claim 1, wherein determining if the user's online activities are directed to promoting the brand comprises:
using one or more computers, determining if the user's status on a social networking platform is directed to promoting the brand.

6. The method of claim 1, wherein determining if the user's online activities are directed to promoting the brand comprises:
using one or more computers, determining if the user's email signature is directed to promoting the brand.

7. The method of claim 1, wherein determining if the user's online activities are directed to promoting the brand comprises:
using one or more computers, determining if the user's status on an instant messaging platform is directed to promoting the brand.

8. The method of claim 1, wherein determining if the user's online activities are directed to promoting the brand comprises:
using one or more computers, determining if the user's avatar on a social networking or instant messaging platform is directed to promoting the brand.

9. The method of claim 1, wherein rewarding the user comprises:
using one or more computers, presenting the user with one or more of rewards points, coupons, discounts, incentives and cash rewards.

10. The method of claim 1, further comprising:
using one or more computers, determining type and amount of the reward based at least in part on number and duration of the user's promotions.

11. A system comprising:
one or more server computers coupled to a network; and
one or more databases coupled to the one or more server computers;
wherein the one or more server computers are for:
detecting if a user is associated with a brand;
presenting an offer to the user to serve as an ambassador for the brand if the user is detected to be associated with the brand;
determining, if the user accepts the offer, if at least a portion of the user's online activities are directed to promoting the brand; and
if at least a portion of the user's online activities are determined to be directed to promoting the brand, presenting one or more rewards to the user based at least in part on the user's promoting of the brand.

12. The system of claim 11, wherein detecting whether the user is associated with a brand comprises:
determining if the user has conducted one or more on-line searches for the brand.

13. The system of claim 11, wherein detecting whether the user is associated with a brand comprises:
determining if the user has used an online service to purchase a product of the brand.

14. The system of claim 11, wherein detecting whether the user is associated with a brand comprises:
predicting whether the user would like to promote the brand.

15. The system of claim 11, wherein determining if the user's online activities are directed to promoting the brand comprises:
determining if the user's status on a social networking platform is directed to promoting the brand.

16. The system of claim 11, wherein determining if the user's online activities are directed to promoting the brand comprises:
determining if the user's email signature is directed to promoting the brand.

17. The system of claim 11, wherein determining if the user's online activities are directed to promoting the brand comprises:
determining if the user's status on an instant messaging platform is directed to promoting the brand.

18. The system of claim 11, wherein determining if the user's online activities are directed to promoting the brand comprises:
determining if the user's avatar on a social networking or instant messaging platform is directed to promoting the brand.

19. The system of claim 11, wherein rewarding the user comprises:
presenting the user with one or more of rewards points, coupons, discounts, incentives and cash rewards.

20. A computer readable medium or media containing instructions for executing a method comprising:
using one or more computers, detecting if a user is associated with a brand, wherein detecting if the user is associated with the brand comprises one or more of:
using one or more computers, determining if the user has conducted one or more on-line searches for the brand;
using one or more computers, determining if the user has used an online service to purchase a product of the brand; and
using one or more computers, predicting if the user would like to promote the brand;
using one or more computers, presenting an offer to the user to serve as an ambassador for the brand if the user is detected to be associated with the brand;
using one or more computers, determining, if the user accepts the offer, if at least a portion of the user's online activities are directed to promoting the brand; and
using one or more computers, if at least a portion of the user's online activities are directed to promoting the brand, presenting one or more rewards to the user based at least in part on the user's promoting of the brand.
